(19) United States
(12) Patent Application Publication
(10) Pub. No.: US 2011/0043073 A1
(43) Pub. Date: Feb. 24, 2011

(54) DRIVE UNIT

(75) Inventors: Achim Hawighorst, Buehlertal (DE); Paul Geubel, Baden-Baden (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/674,774

(22) PCT Filed: Sep. 12, 2008
(86) PCT No.: PCT/EP08/62155

§ 371 Date: Feb. 23, 2010

(30) Foreign Application Priority Data
Nov. 8, 2007 (DE) 10 2007 053 272.7

(51) Int. Cl. H01R 39/38

(52) U.S. Cl. 310/245

(57) ABSTRACT

The invention relates to a drive unit, particularly a geared motor for windshield wipers, window lifting devices, or the like, of a motor vehicle, having a gear in a gear housing (14) and commutator motor disposed in a motor housing (12), comprising a stator (18) and a rotor (20), which together with a commutator (28) is disposed on a shaft (22) projecting into the gear housing (14). A brush holder (33) positioned in the gear housing (14) for at least two brushes (30, 31) adjacent to the commutator (28) under the pressure of double journal brush springs (32, 33) is configured substantially in a U shape and has locking devices (46, 48) for supporting the brush springs (32, 33) in a positive fit on at least one side.

### BACKGROUND OF THE INVENTION

The invention relates to a drive unit, in particular to a geared motor for windshield wipers, window winders or the like in a motor vehicle.

WO 03/100 920 A1 discloses a brush arrangement for an electric motor, which has brush springs similar to leaf springs in order to press the brushes against the commutator, wherein the brush part has limbs which extend away from the brush on both sides, and by means of which the brush spring is connected to the brush holder and is pressed elastically against the commutator. The limbs of the brush springs have angled sections which are arranged offset with respect to the motor axis and are screwed to the brush holder. Elements such as these involve a relatively large amount of complexity, both for production and for assembly.

### SUMMARY OF THE INVENTION

The drive unit according to the invention and having the features of the independent claim in contrast has the advantage that the brush holder that is used and the associated brush springs can be produced easily and at low cost, and can be mounted in the drive unit easily and without aids, to be precise advantageously after the fitting of the rotor and the commutator of the machine. In particular this avoids process steps and aids for locking the brushes while the commutator is being introduced.

Advantageous developments and improvements of the apparatus specified in the independent claim are possible by means of the measures stated in the dependent claims. It is particularly advantageous in this case that, when the spring is being fitted into the brush holder, a lock on the brush holder clasps one spring end of the brush spring in an interlocking manner, thus simplifying the insertion process and at the same time ensuring that the spring is positioned exactly and securely. Expediently, the brush spring is essentially C-shaped and the associated brush is arranged centrally on the spring, thus resulting in a uniform force distribution between the spring limbs and, in consequence, uniform wear of the brush, in the installed state. In addition, this arrangement and configuration of the brush spring ensures that the brush rests on the commutator securely and permanently in a prestressed manner during operation, without any additional attachment means, and that their contact point does not change when the brush wears.

For simple and rapid fitting of the brush springs with the brushes attached to them, it is also advantageous for the U-shaped brush holder to have openings in its central limb for the brush springs to be threaded into during fitting, once the rotor of the machine and, with it, the commutator, have already been positioned and fitted. This on the one hand makes it easier to fit the commutator while on the other hand ensuring that once the commutator has already been fitted, the contact pressure for positioning of the brush springs is produced during the subsequent insertion of the brush springs with the brushes. The interlocking locks for the brush springs are in this case expediently arranged such that they are opposite the openings for insertion of the burshes and thus already hold the front end of the brush springs in the correct final position during insertion.

Further details and refinements of the invention will become evident from the dependent claims and the description of one embodiment of the invention.

### BRIEF DESCRIPTION OF THE DRAWINGS

One exemplary embodiment of the invention will be explained in more detail in the following description, and is illustrated in the drawings, in which:

FIG. 1 shows a schematic and reduced longitudinal section through a drive unit according to the invention,

FIG. 2 shows a plan view of the brush holder of the commutator motor, as indicated by the arrow II in FIG. 1, and

FIG. 3 shows a section through the brush holder of the commutator motor, as indicated by the section line III-III in FIG. 1.

### DETAILED DESCRIPTION

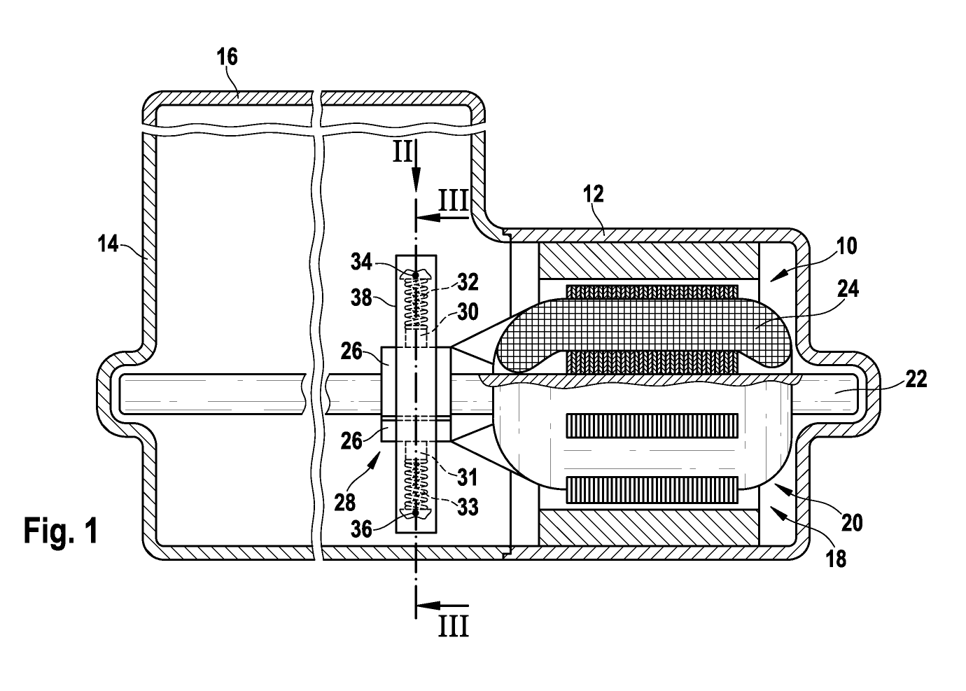

In FIG. 1, 10 denotes a schematically illustrated direct-current motor of a drive unit, which is arranged in a motor housing 12 to which a gear box housing 14 is flange-connected. The gear box housing is closed by a gear box cover 16, which allows access for fitting purposes when removed.

The direct-current motor 10 is in the form of a commutator motor with a stator 18 and a motor 20, whose shaft 22 extends as a drive shaft into the gear box housing 14, and is fitted with gear box parts, which are not illustrated. The rotor winding is annotated 24 and is electrically conductively connected to the laminates 26 of a commutator 28, which is likewise mounted on the shaft 22. Brushes 30 and 31 slide on the circumference of the commutator and are pressed against the commutator 28 in the radial direction by brush springs 32 and 33, which are indicated symbolically. The connections of the brush springs 32 and 33 are connected to a positive pole 34 and to a negative pole 36 of a DC voltage source.

The exemplary embodiment shows a direct-current motor 10 with two brushes, as is used by way of example for rear windshield wipers of motor vehicles. However, if required, a third brush can also be arranged in a known manner on the commutator, on the basis of a second motor speed step. The capability to provide a third brush for a second speed step also applies to all the following embodiments although, for the sake of simplicity, the rest of the description is based on a motor configuration with two brushes in a U-shaped brush holder 38.

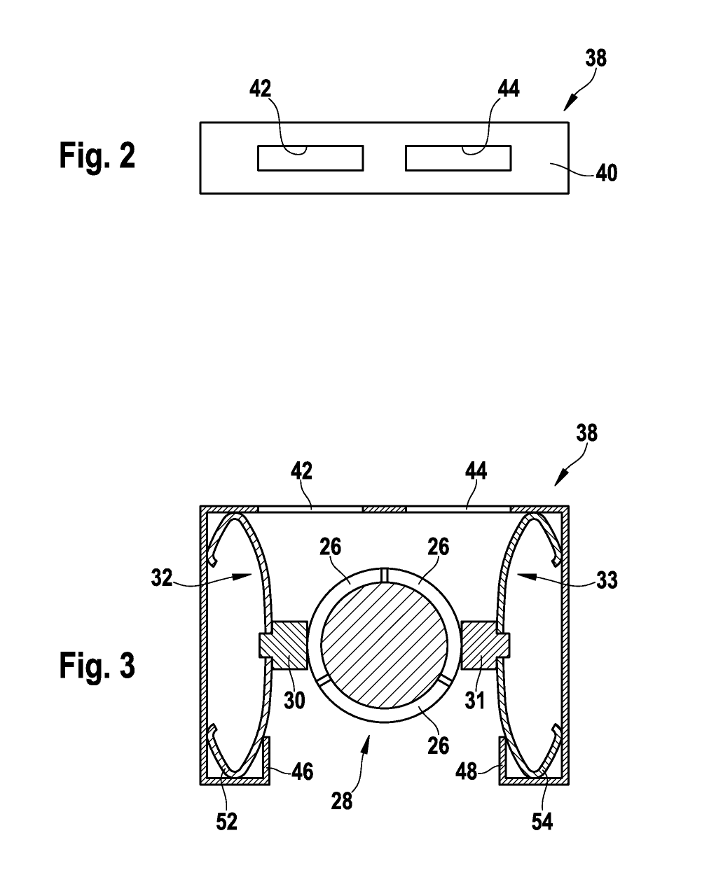

FIG. 2 shows a plan view of the brush holder 38 in the direction of the arrow II in FIG. 1. In this case, only the central limb 40 of the brush holder 38 can be seen, having two openings 42, 44 for the fitting of the brush springs 32, 33 after the rotor 20 and the commutator 28 have been fitted in the motor housing 12, to be precise in the gear box housing 14. The brush holder 38 itself can optionally be fitted before or after the commutator 28.

In a section along the line III-III in FIG. 1, FIG. 3 shows, in more detail, the configuration of the U-shaped brush holder 38 and the position of the two brush springs 32 and 33 with the brushes 30 and 31. The brushes 30 and 31 are in this case connected to the brush springs 32 and 33 in an interlocking and force-fitting manner, by adhesive bonding or soldering. After the commutator 28 has been fitted, they can be introduced obliquely from above into the brush holder through the openings 42 and 44 in the brush holder 38, being elastically deformed in the process, and being securely locked and positioned in the position illustrated in FIG. 3. The schematic illustration in FIG. 3 does not show the electrical contact between the brush springs 32 and 33 and the brushes 30 and 31, which are conductively connected to them.

In order to position the C-shaped brush springs 32, 33, which are formed symmetrically with respect to the brushes 30, 31, a respective lock 46 and 48 clasps the respective lower end 52 and 54 of the springs, which ends face away from the openings 42 and 44 and are bent to a greater extent than the center part of the springs 32, 33, thus, in conjunction with the prestressing produced by the contact with the commutator 28, ensuring exact positioning of the brush springs. If a third brush is also intended to be accommodated in the brush holder 38, then two brush springs are each mounted in fundamentally the same manner obliquely in the area of a side limb of the brush holder 38, with an additional lock being fitted, corresponding to the locks 46 and 48.

1. A drive unit, having a gear box housing (14) which can be closed by a gear box cover (16), having a motor housing (12) which is connected to the gear box housing, having a rotor (20) which is arranged in the motor housing and is arranged together with a commutator (28) on a shaft (22) which projects into the gear box housing (14), and having a brush holder (38) for at least two brushes (30, 31) which rest on the commutator (28) subject to the pressure of two-limbed brush springs (32, 39), characterized in that an essentially U-shaped brush holder (33) is arranged in the gear box housing (14) and has locks (46, 48) in order to support the brush springs (32, 33) in an interlocking manner on at least one side.

2. The drive unit as claimed in claim 1, characterized in that a lock (46, 48) clasps a spring end (52, 54) of each brush spring (32, 33).

3. The drive unit as claimed in claim 1, characterized in that the brush springs (32, 33) are essentially C-shaped and are fitted centrally with a brush (30, 31).

4. The drive unit as claimed in claim 1, characterized in that the brush springs (32, 33) rest on the commutator (28) in a prestressed manner in the installed state and are in this case fixed in their lock (46, 48) on the brush holder (38).

5. The drive unit as claimed in claim 1, characterized in that the brush holder (38) has openings (42, 44) for fitting of the brush springs (32, 33) after fitting of the commutator (28).

6. The drive unit as claimed in claim 5, characterized in that the openings (42, 44) for fitting of the brush springs (32, 33) are located in the central limb (40) of the U-shaped brush holder (38).

7. The drive unit as claimed in claim 1, characterized in that the interlocking locks (46, 48) for the springs (32, 33) are arranged on that side of the brush holder (38) which faces away from the openings (42, 44).

8. The drive unit as claimed in claim 1, characterized in that, in the fitted state, the brush springs (32, 33) are supported on the one hand in an interlocking lock (46, 48) on the open side of the brush holder (38) and on the other hand on a wall section of the central limb (40) of the U-shaped brush holder (38), to the side of the openings (42, 44) for the fitting of the brush springs (32, 33) and of the brushes (32, 33).

9. The drive unit as claimed in claim 1, characterized in that the brush springs (32, 33) are formed symmetrically with respect to the brush (31, 32).

10. The drive unit as claimed in claim 1, characterized in that the brushes (31, 32) are connected to the brush springs (32, 33) in an interlocking and force-fitting manner.

11. The drive unit as claimed in claim 2, characterized in that the brush springs (32, 33) are essentially C-shaped and are fitted centrally with a brush (30, 31).

12. The drive unit as claimed in claim 11, characterized in that the brush springs (32, 33) rest on the commutator (28) in a prestressed manner in the installed state and are in this case fixed in their lock (46, 48) on the brush holder (38).

13. The drive unit as claimed in claim 12, characterized in that the brush holder (38) has openings (42, 44) for fitting of the brush springs (32, 33) after fitting of the commutator (28).

14. The drive unit as claimed in claim 13, characterized in that the openings (42, 44) for fitting of the brush springs (32, 33) are located in the central limb (40) of the U-shaped brush holder (38).

15. The drive unit as claimed in claim 14, characterized in that the interlocking locks (46, 48) for the springs (32, 33) are arranged on that side of the brush holder (38) which faces away from the openings (42, 44).

16. The drive unit as claimed in claim 15, characterized in that, in the fitted state, the brush springs (32, 33) are supported on the one hand in an interlocking lock (46, 48) on the open side of the brush holder (38) and on the other hand on a wall section of the central limb (40) of the U-shaped brush holder (38), to the side of the openings (42, 44) for the fitting of the brush springs (32, 33) and of the brushes (32, 33).

17. The drive unit as claimed in claim 16, characterized in that the brush springs (32, 33) are formed symmetrically with respect to the brush (31, 32).

18. The drive unit as claimed in claim 17, characterized in that the brushes (31, 32) are connected to the brush springs (32, 33) in an interlocking and force-fitting manner.

19. The drive unit as claimed in claim 1, wherein the drive unit is a geared motor for windshield wipers, window winders or the like in a motor vehicle.
